(19) United States
(12) Patent Application Publication
(10) Pub. No.: US 2005/0138143 A1
(43) Pub. Date: Jun. 23, 2005

(54) Pre-fetching linked content

(76) Inventor: Blake A. Thompson, Lehi, UT (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,816

(22) Filed: Dec. 23, 2003

(51) Int. Cl. G06F 15/16

(52) U.S. Cl. 709/218

(57) ABSTRACT

The invention generally relates to prioritizing fetching content from a hierarchy of network resources defined with respect to links between the network resources. Typically a network resource, such as a web page, contains links to substantive content of interest to a data consumer, such as links to successive pages of an article, and ancillary data, such as links to advertisements or other data. If a network connection is intermittent, such as for a mobile computing device, associating prefetch tags with links to substantive within a network resource may facilitate maximizing use of a transitory network connection by having the marked substantive content prefetched in advance of its access by a data consumer so that the prefetched content may remain available to the data consumer even if the network connection is lost.

### FIELD OF THE INVENTION

The invention generally relates to prioritizing fetching content from a hierarchy of network resources defined with respect to links between the network resources, and more particularly to associating priorities with hyperlinks between data sources to identify high priority network resources within the hierarchy that should be prefetched while a possibly intermittent network connection is present, so that the high priority network resources remain available if later access to the network is unavailable.

### BACKGROUND

Current network web browser application programs provide basic client- side caching techniques of accessed network resources. Typical client-side caching techniques include the browser history provided by the Microsoft Internet Explorer web browser, or the web cache provided by the Netscape Communications web browser. These caching techniques apply to resources already accessed by a client. Few techniques are available to cache content not yet accessed; one rudimentary technique is the “Make Available Offline” option provided by Microsoft Internet Explorer. When this option is selected, Internet Explorer recursively traverses, e.g., “crawls,” a designated web page and all pages linked to by the designated page.

A “web hierarchy” may be defined as the designated web page contents, as well as all network resources, e.g., other web pages, images, sounds, movies, scripts, etc., linked to by the designated web page. Since a web page may refer to another web page, which in turn may refer to yet another web page, and so on, a full traversal from the designated web page may encompass an enormous amount of data. Consequently, to prevent storing too much data, Internet Explorer limits the number of sub-levels in the web hierarchy off the designated web page which may be traversed and stored. This limiting of storage may result in failure to capture information that is deemed important to a reader of content on the designated web page.

For example, consider an online news article. In an effort to maximize revenue from providing such articles on the Internet, a common technique by web sites is to present a small portion of the article along with many advertisements and other items taking up screen real estate. A reader of the article is thus required to select an appropriate hypertext link, web page button, or other such control to access the “next page” of the article, responsive to which another portion of the article is displayed alongside more advertisements and other items on the subsequent web page. In such fashion, there may be many such “pages” that need to be accessed to obtain the entire article. If the reader of the article needs to stop reading temporarily, such as due to loss of a network connection in a mobile environment, having to stop network access such as when flying on an airplane, or for some other reason, the reader may attempt to store the page offline with Internet Explorer. Unfortunately, if the depth of the web hierarchy for the article is too deep, Internet Explorer will fail to capture the entire article, thus leaving the reader unable to complete the article until network connectivity is restored.

### BRIEF DESCRIPTION OF THE DRAWINGS

The features and advantages of the present invention will become apparent from the following detailed description of the present invention in which:

FIG. 1 illustrates, according to one embodiment, an exemplary HTML tag for identifying substantive content within HTML that should be prefetched.

FIG. 2 illustrates a usage scenario according to one embodiment.

FIG. 3 illustrates according to one embodiment prefetching operations of a network application program, such as a web browser.

FIG. 4 illustrates a suitable computing environment in which certain aspects of the invention may be implemented.

### DETAILED DESCRIPTION

While the above discussion has focused on obtaining a complete copy of an article spread across multiple levels of a web hierarchy, it will be appreciated the problem of obtaining a complete copy of the article applies to other data formats that may be segmented such that obtaining a complete copy of the data requires engaging in a sequence of data accesses.

Thus, while the description below will focus, for expository convenience on obtaining an article, in the claims that follow, the phrase “data consumer” will be used to obtaining any kind of data that is spread across a “hierarchy,” whether the data is an article spread across a “web hierarchy” as discussed above, or an audio sequence, video sequence, or other kind of data spread across a web hierarchy or other data hierarchical structure defined by an access sequence, e.g., the data structure defined by a sequence of data accesses required to obtain all portions of some desired data, whether it be a sequence of web pages to retrieve an article, or the sequence of data accesses required to obtain an audio or video presentation, etc. The present disclosure is also intended to encompass operations within network application programs other than a web browser, such as a media player, animation player, or the like, that enables one to sequentially access segments of desired data.

Problems with obtaining a complete copy of an article or other data of interest to a data consumer is often times made more difficult if the consumer's network connectivity is based on wireless networking technology. A wireless network connection may only be intermittently present, with connectivity depending on various factors including the location of a wireless client, available Wireless Access Points (WAPs) (the device having a network connection being shared with the wireless client), and interference from other devices such as other wireless devices sharing the same communication frequencies, or devices that are known to wreak havoc with wireless communications, e.g., microwave ovens. Interference from these and other devices may cause a network connection to suddenly drop.

It would be helpful if a data creator, such as the author of an article, could embed hints in the data's hierarchy to facilitate distinguishing between substantive content, and other content, such as advertising or other ancillary information conveyed along with the substantive content. Such hints would allow a network application program, such as a web browser to prioritize data caching while a network connection is present by traversing the hierarchy and obtaining and caching the substantive content. Thus, even if the network connection becomes unavailable, a data consumer, such as one using a web browser to read an article, will be able to access the entire article from a local cache even though ancillary data on the web pages is no longer available.

Further, if a device is configured to enter a lower power state rather than fully powering off, e.g., it is “Always On,” it may be configured to monitor for available network connectivity even though the device is in an “off” state, thus allowing the device to (possibly intermittently) continue to retrieve substantive data as networks become available. Thus, even if a device is powered off before it was able to retrieve the entire substantive content for desired data, the device may nonetheless be able to retrieve the rest of the substantive content as network connectivity is identified.

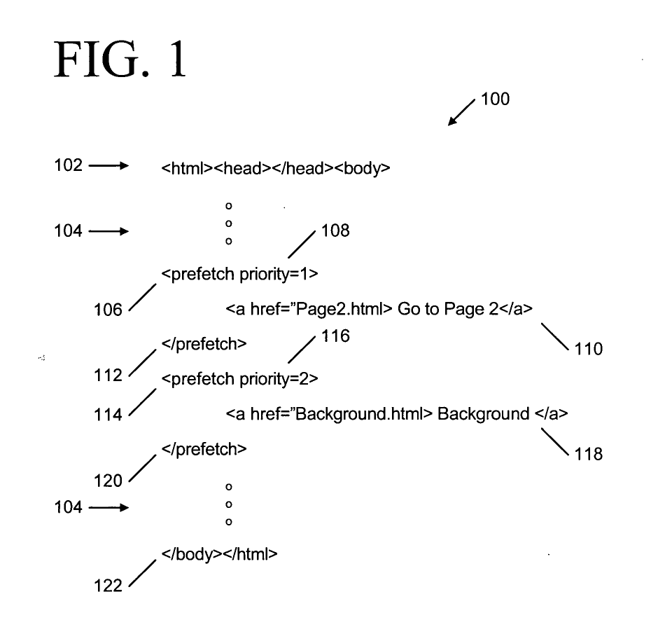

FIG. 1 illustrates, according to one embodiment, an exemplary HyperText Markup Language (HTML) tag which may be used to identify substantive content within the HTML code 100 for a web page. It will be appreciated that a web page or other accessed resource may be constructed in many different programming languages, and that the illustrated link may be appropriately represented in these other languages, e.g., the illustrated HTML is presented for exemplary purposes only.

In the illustrated embodiment, shown are typical HTML “head” and “body” tags 102 that may be used to start the definition of a particular web page. As will be understood by one skilled in the art, the illustrated HTML code is rudimentary, and does not show other code 104 that would ordinarily be present in the structural definition and content presentation of the web page. At some point in the web page definition, a “prefetch” tag 106 may be defined. In this embodiment, prefetch tags, along with their corresponding closing tags 112, 120, determine regions of the web page that should receive priority processing. As discussed above, use of a prefetch tag by a data creator, such as an author of substantive content on the web page, allows the data creator to identify links 110, 118 to other substantive content that the data creator thinks should be prefetched and cached on a priority basis, e.g., before processing some or all of the other code defining the web page.

In one embodiment, multiple prefetch tags 106, 114, may be used within a web page, and optionally, the prefetch tags may include a priority identifier 108, 116 to allow optimizations among the data to prefetch and cache. For example, while both of the illustrated prefetch tags 106, 114 identify links to substantive content, the first link 110 identifies a link to a second page of the web page, while the second link 118 identifies a link to some background information. Assuming the data creator values the content at the second page more highly than the background information, the data creator may optionally associate priority values (shown as HTML in-tag variable definitions) 108, 116.

Since the first link 108 has a higher priority, its linked data, e.g., page 2, will be prefetched and cached before doing the same for the background information identified by the second link 118. Thus, if a network connection is short-lived, a data creator can increase the chances that the most important content, such as the remaining pages of an article, are prefetched first so that they may be reviewed even if the network connection is lost.

It will be appreciated that while only single links 110, 118 are illustrated in the two prefetch regions defined by the prefetch start/end tags 106/112, 114/120, there may be multiple links (not illustrated) within each region. Further, while not illustrated, it is expected that prefetch regions may be defined within other prefetch regions, thus allowing an arbitrary level of detail in controlling what content and in what order content of linked web pages is retrieved. If all links in the web page have no specified priority, or if the specified priorities are all the same, then in one embodiment, the links are prefetched and cached in the order in which they appear in the code 100.

In one embodiment, a network application program, such as a web browser, that is processing the code 100, may maintain a queue identifying the order in which data should be prefetched and cached. Thus, if a machine suddenly goes off line, the queue may maintain current prefetch state so that prefetching may continue when a network connection returns. This is particularly useful in “Always On” devices that may process the queue, even if in a low-power state, as network connections become available

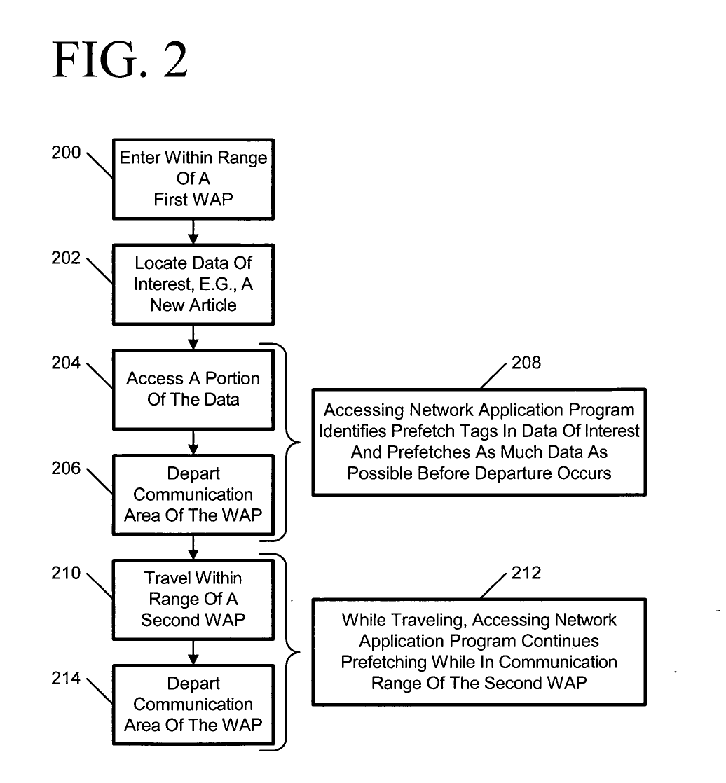

FIG. 2 illustrates a usage scenario according to one embodiment. As illustrated, a data consumer, such as a user of a mobile computer, enters 200 within communication distance of a wireless access point (WAP), such as an access point implementing one of the Institute of Electrical and Electronics Engineers (IEEE) 802.11 family of wireless communication specifications, e.g., 802.11a, 802.11b, 802.11g, etc.

As discussed above, WAPs are becoming widely accessible, including access at locations such as bookstores, coffee shops, fast food restaurants, etc. While at one of these locations, the data consumer locates 202 data of interest, e.g., data to consume, such as a news article of interest to the consumer. Locating the data may occur under a variety of circumstances, such as while waiting to complete a purchase transaction with a vendor at the WAP location.

In the illustrated embodiment, after only briefly accessing 204 the data of interest, the data consumer departs 206 the communication area of the WAP.

Under a conventional browsing model, the data consumer's browser has only cached the data already accessed. However, as discussed previously, the data consumer could attempt to save the rest of the article for later review. But, as discussed above, existing caching techniques are insufficient to ensure the entire article may be obtained for later review, especially if the current network connection is only transitory before the data consumer departs 206 the WAP's communication area. But, if the data of interest was formatted with prefetch tags, e.g., such as described with respect to FIG. 1, while the data consumer was accessing 204 the data, the accessing network application program may also silently identify prefetch tags in the data of interest and then prefetch 208 as much data as possible before the departure 206.

Thus, if after departure 206 the data consumer attempts to continue to access the data of interest, e.g., continue reading the article, while some elements of a web page or other accessed resource might not be available, e.g., advertisements might not have been cached, successive portions of the data of interest may have been cached and can be presented for continued review. Note that while prefetch tags allow distinguishing between substantive content and other data, such as advertisements, an advertiser may arrange with a data creator to have certain advertising content included within prefetch tags. The content identified by prefetch tags is arbitrary.

For the illustrated embodiment, assume that the entire data of interest identified by prefetch tags was not prefetched before departure 206, and assume that after departing the first WAP, while traveling to another destination, the data consumer temporarily travels 210 within range of a second WAP. For example, the data consumer may be traveling through an airport, initially stopped to purchase some food in an area having the first WAP, and is now walking a concourse towards a gate area having the second WAP. When communication is established with this second WAP, the accessing network application program may continue 212 prefetching as much of the data of interest as possible before a departure 214 from the communication area.

Thus, again, if after departure 214 the data consumer attempts to continue to access the data of interest, e.g., continue reading the article, while some elements of a web page or other accessed resource might not be available, further portions of the data of interest may have been prefetched 212 for continued review.

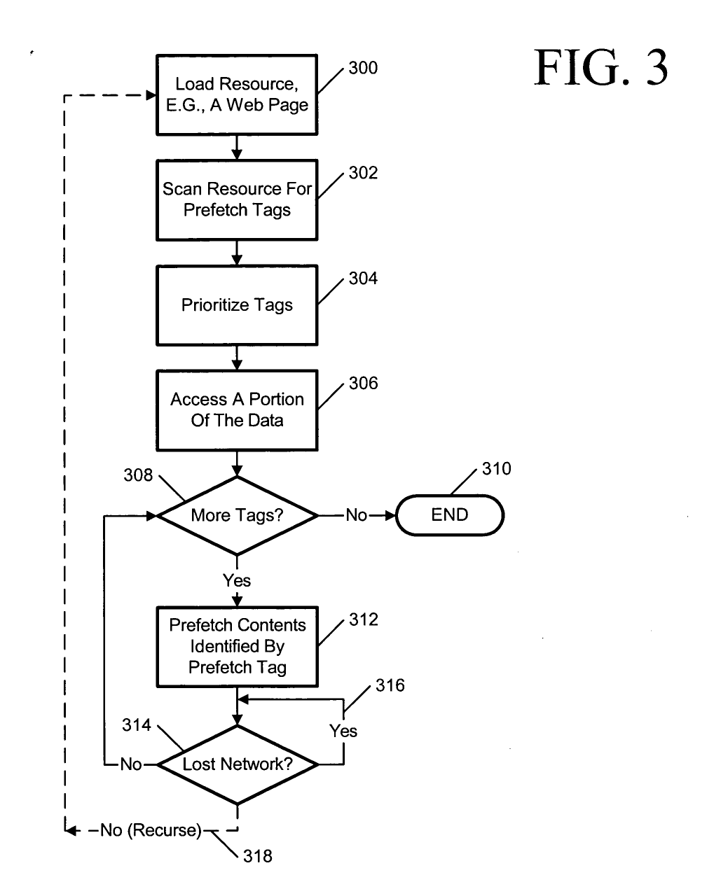

FIG. 3 illustrates according to one embodiment prefetching operations of a network application program, such as a web browser. The network application program is directed to load 300 a network resource, such as a web page. In response, the network application program scans 302 the requested resource for prefetch tags, such as the tags described with respect to FIG. 1, and, in the illustrated embodiments, prioritizes 304 the tags to identify network resources that should be prefetched first.

While the network application program accesses 306 the network resource, for example, to load the first page of an article, the network application program continues to process prefetch tags identified within the network resource. For example, in a web page context, the browser network application program may check to see if 308 there are remaining prefetch tags defined within the network resource, e.g., the code for a particular web page, that have not yet been processed. If not, then prefetch processing terminates 310. If 308 so, the network application program prefetches 312 the contents identified by the prefetch tag, e.g., in the context of a web page link, a browser network application program may cache the network resource or resources, e.g., a web page, identified by a Uniform Resource Locator (URL).

It will be appreciated that prefetching content may be performed as a breadth first search, depth first search, some combination of the two, or according to another search algorithm. For example, in one implementation of a depth first search, one could prioritize 304 prefetch tags on the loaded 300 resource, prefetch 312 the contents identified by one of the prefetch tags, and then recursively process the prefetched contents, e.g., as illustrated by dashed (to show optional behavior) line 316, the illustrated operations may be recursively applied to prefetched 312 contents. Note that in a recursive configuration, end operation 310 corresponds to falling out of a recursive level and continuing on with tags remaining to be processed in the current recursive level until all tags have been processed (or some limits reached).

For some devices, such as mobile devices being transported, it is likely that the network connection being used to prefetch content will eventually be lost. If the network connection is lost while prefetching data, then the device may periodically test to determine if 314 the network connection is still lost. If so, the device may loop back 316 and wait/test for renewed network connectivity. If 314 the network connection is restored, then processing may continue with testing if 308 there are more tags to process.

In one embodiment, an entire hierarchy can be scanned to first locate prefetch tags and associated priorities, if any, within the hierarchy, and then contents throughout the hierarchy may be cached in accordance with their prefetch priorities. It will be appreciated that a hierarchy may essentially be considered limitless in size, and/or it may describe a circular graph; hence limits may be imposed to control the number of recursive operations, depth traversals, etc.

It will be appreciated that data creators or content publishers may employ a revenue model in which advertisers are given an opportunity to pay a premium to have advertisements marked with prefetch tags so that the advertisement would be prefetched along with substantive content. It will be appreciated that priority identifiers, see, e.g., FIG. 1 items 108, 116, may be used to give advertisements a higher or lower priority with respect to other advertisements or substantive content. For example, in one embodiment, substantive content may have a highest priority identifier, high paying advertisers may share a lower priority along with links to lower priority substantive content such the second link 118 discussed with respect to FIG. 1, while other advertisers and links to other non-substantive content may have still lower (or none at all) assigned priorities, resulting in their prefetching only occurring after obtaining other higher priority substantive content and revenue generating advertising.

In such fashion, as described above, prefetch tags (or their equivalent depending on the encoding nature of network resources) may be used by a data creator or data publisher to identify substantive content most likely to be of interest to a data consumer. If this substantive content is automatically (and transparently) prefetched, such as while the data consumer reviews some portion of the data of interest, such prefetching facilitates maximizing the efficient usage of limited-time or limited-bandwidth network connections, and may be used to again maximize usage of network connections that may intermittently become available.

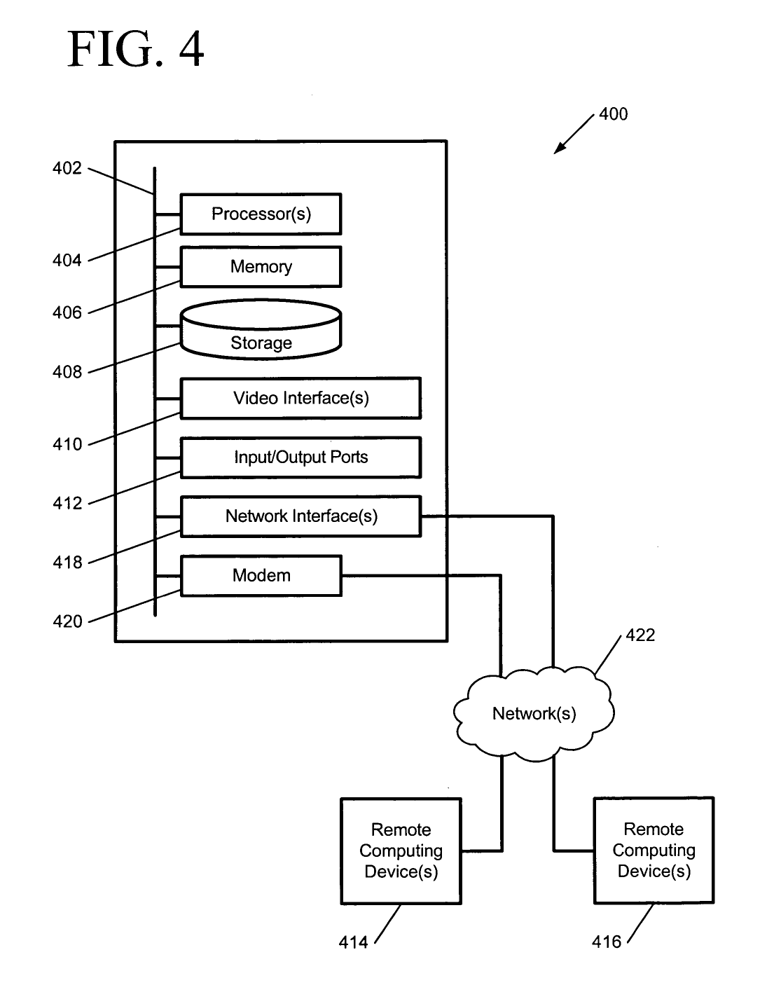

FIG. 4 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include computing devices such as personal computers, workstations, servers, portable computers, handheld devices, e.g., Personal Digital Assistant (PDA), telephone, tablets, etc., as well as transportation devices, such as private or public transportation, e.g., automobiles, trains, cabs, etc.

Typically, the environment includes a machine 400 that includes a system bus 402 to which is attached processors 404, a memory 406, e.g., random access memory (RAM), read-only memory (ROM), or other state preserving medium, storage devices 408, a video interface 410, and input/output interface ports 412. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 414, 416, such as through a network interface 418, modem 420, or other communicative coupling. Machines may be interconnected by way of a physical and/or logical network 422, such as an intranet, the Internet, local area networks, and wide area networks. One skilled in the art will appreciated that communication with network 422 may utilize various wired and/or wireless short range or long range carriers and protocols, including the IEEE 802.11 protocols discussed above, as well as radio. frequency (RF), satellite, microwave, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Associated data may be stored in, for example, volatile and/or non-volatile memory 406, or in storage devices 408 and their associated storage media, including hard-drives, floppy-disks, optical storage, tapes, flash memory, memory sticks, digital video disks, biological storage, etc. Associated data may be delivered over transmission environments, including network 422, in the form of packets, serial data, parallel data, propagated signals, etc., and may be used in a compressed or encrypted format. Associated data may be used in a distributed environment, and stored locally and/or remotely for access by single or multi-processor machines.

Thus, for example, with respect to the illustrated embodiments, assuming machine 400 embodies a mobile computer attempting to load a web page including an article of interest to a user of the mobile computer, then remote machines 414, 416 may respectively be a web server hosting the web page accessed by the mobile computer, and an advertiser having resources linked to by the web page. It will be appreciated that remote machines 414, 416 may be configured like machine 400, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

1. A method for prioritizing prefetching substantive content over an intermittent network connection, comprising:
accessing a first network resource including a first substantive content, at least one link to other substantive content accessible at an at least one second network resource, and at least one link to non-substantive content accessible at an at least one third network resource;
scanning the first network resource to determine prefetch tags identifying the at least one link to other substantive content;
prioritizing said determined prefetched tags, the prioritizing including determining a prefetch priority for selected ones of the at least one link to other substantive content;
determining if network connectivity is available; and
if so, prefetching the other substantive content of the second network resource in accordance with said prioritizing if network connectivity is determined available, said prefetching occurring before accessing the third network resource.

2. The method of claim 1, further comprising:
recursively applying the method said accessed second network resource.

3. The method claim 1 wherein the first network resource comprises a first web page.

4. The method of claim 1, wherein accessing the first network resource is performed with a web browser.

5. The method of claim 1, further comprising:
determining network connectivity is unavailable; and
responsive thereto, pausing said prefetching substantive content.

6. The method of claim 1 wherein the first network resource is described with a tag based language.

7. The method of claim 1 wherein the first network resource is encoded with selected ones of: the HyperText Markup Language (HTML), the extensible Markup Language (XML), the Simple Object Access Protocol (SOAP), and Standard Generalized Markup Language (SGML).

8. The method of claim 1, wherein the third network resource includes an advertisement.

9. A memory storing a first data structure interpretable by a network application program, the first data structure comprising:
a begin identifier signaling a start of the first data structure;
an end identifier signaling an end to the first data structure; and
a body portion defined with respect to the begin and end identifiers, the body portion including at least one priority link to a first priority network resource; and
wherein if the first data structure is incorporated into a network resource including links to non-priority network resources, when the network application program accesses the network resource and interprets the first data structure, the network application program prefetches the priority network resource before accessing all of the other links to non-priority network resources.

10. The memory of claim 9, the first data structure further comprising:
a priority identifier for storing a relative ranking of the first data structure with respect to a second such data structure identifying a second priority network resource;
wherein if the second data structure has a lower-priority than the first data stricture, the network application program accesses the first priority network resource before accessing the second priority network resource.

11. The memory of claim 9, wherein the data structure has a tag based structure.

12. The memory of claim 9 wherein the tag based structure complies with a selected on of the following data formats: HTML, XML, and SOAP.

13. A system for a first machine to prefetch substantive content from a second machine before accessing advertising content of a third machine, comprising:
the first machine operable to access network resources of the second machine and the third machine over a network; and
the second machine operable to provide at least a first network resource and a second network resource, said resources addressable over the network by way of first and second links thereto, the first network resource including a prefetch marker associated with the second link within the first network resource linking to the second network resource, and a third link to an advertisement provided by the third machine.

14. The system of claim 13, wherein the first machine is further operable to access the first network resource with the first link, scan the first network resource to determine the prefetch marker, and responsive to said determining the prefetch marker, to prefetch the second network resource prior to accessing the advertisement of third machine.

15. The system of claim 13, wherein the first machine is intermittently coupled to the network.

16. The system of claim 13 further comprising a Wireless Access Point (WAP) communicatively coupled with the network and providing wireless access thereto.

17. The system of claim 16, wherein the first machine is wirelessly coupled to the network.

18. An article comprising a machine-accessible media having associated data for prioritizing prefetching substantive content over an intermittent network connection, wherein the data, when accessed, results in a machine performing:
accessing a first network resource including a first substantive content, at least one link to other substantive content accessible at an at least one second network resource, and at least one link to non-substantive content accessible at an at least one third network resource;
scanning the first network resource to determine prefetch tags identifying the at least one link to other substantive content;
prioritizing said determined prefetched tags, the prioritizing including determining a prefetch priority for selected ones of the at least one link to other substantive content;
determining if network connectivity is available, and if so, prefetching the other substantive content of the second network resource in accordance with said prioritizing if network connectivity is determined available, said prefetching occurring before accessing the third network resource.

19. The article of claim 16 wherein the machine-accessible media further includes data, when accessed, results in the machine performing:
recursively accessing the second network resource.
